(19) United States
(12) Patent Application Publication
(10) Pub. No.: US 2006/0036505 A1
(43) Pub. Date: Feb. 16, 2006

(54) Method and system for distributing digital works

(75) Inventor: Frank J. Jakubaitis, Buena Park, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: NETPACK, INC.

(21) Appl. No.: 11/079,579

(22) Filed: Mar. 14, 2005

Related U.S. Application Data
(63) Continuation of application No. 09/607,202, filed on Jun. 28, 2000.
(60) Provisional application No. 60/140,929, filed on Jun. 28, 1999.

(51) Int. Cl. G06Q 30/00

(52) U.S. Cl. 705/26

(57) ABSTRACT

A system for distributing digital works includes a package associated with a desired one of the digital works, a customer node used by a customer, and a remote server. The remote server and the customer node are intermittently coupled through a communications link which includes a public communications network, preferably the Internet. The digital works and their associated identification data are first stored on a memory of the remote server. To distribute the digital works, the customer purchases from the retail merchant the package associated with the desired one of the digital works, which includes the desired digital work's identification data. The customer then connects from the customer node through the public communications network to the remote server. The customer node sends a request to access the desired digital work through the public communications network to the remote server, specifying the desired digital work's identification data included in the purchased package. The remote server receives the request to access the desired digital work and searches the digital works stored on the remote server for the desired digital work specified by the identification data in the received request. If the desired digital work is found, it is transmitted from the remote server through the public communications network to the customer node. When the desired digital work is received at the customer node, it is stored on a memory of the customer node for subsequent access and use by the customer.

### RELATED APPLICATIONS

This application claims the benefit of U.S. Provisional Application No. 60/140,929, entitled “NetPack Special Application Package” and filed Jun. 28, 1999.

### BACKGROUND

1. Field of the Invention

This invention relates to methods and systems for distributing digital works, and in particular embodiments, methods and systems for distributing digital works among a retail merchant at a merchant node, a remote server, and a customer at a customer node through a public communications network.

2. Related Art

The Internet is a worldwide system of computer networks which allows users at any one computer to exchange computer data with users at any other computer. The World Wide Web (“WWW”) is the most widely used part of the Internet. The WWW is based on the exchange of information between server and client computers. Each server computer has software, called a web server, and each client computer has software, called a web browser, for exchanging information over the WWW. One or more server computers store graphical pages of information, called web pages, which make up a web site. The WWW allows the server computer to send web pages to a user's client computer and allows the client computer to display the web pages. The web pages may contain certain words or phrases, buttons, or images which are “clickable” and allow the user to request and display related web pages of information in a hypertext fashion.

In recent years, the buying and selling of goods and services on the WWW, otherwise known as electronic commerce or e-commerce, has greatly increased in popularity. One problem with conducting e-commerce on the WWW is that it requires the customer to shop, sitting down in front of a computer and-using an Internet connection. However, most customers still prefer to conduct their shopping at traditional retail merchants where computers and Internet connections are not readily available for use by all customers. Therefore, e-commerce companies are unable to offer their products and services for sale in a traditional retail environment. Additionally, there is still some customer concern about performing financial transactions, such as using credit card numbers, over the WWW to purchase products and services.

Accordingly, it would be preferred to develop a method and a system for distributing digital works which allows consumers to purchase Internet-based products and services at traditional retail merchants without the need of a computer or Internet connection at the time of purchase.

### BRIEF DESCRIPTION OF THE DRAWINGS

A detailed description of embodiments of the invention will be made with reference to the accompanying drawings, wherein like numerals designate corresponding parts in the several figures.

FIG. 1 is a block diagram illustrating a system for distributing digital works in accordance with an embodiment of the present invention.

FIGS. 2A and 2B illustrate a sample package associated with a digital work which is available for purchase at a retail merchant in accordance with an embodiment of the present invention.

FIGS. 3A and 3B illustrate another sample package associated with a digital work which is available for purchase at a retail merchant in accordance with another embodiment of the present invention.

FIG. 4 illustrates a sample web page for downloading a digital work from a remote server through a public communications network to a customer node in accordance with an embodiment of the present invention.

### DETAILED DESCRIPTION OF THE PREFERRED EMBODIMENTS

As shown in the drawings for purposes of illustration, embodiments of the present invention include a method and a system for distributing digital works among a retail merchant at a merchant node, a remote server, and a customer at a customer node through a public communications network, preferably the Internet. In preferred embodiments of the present invention, the method utilizes and the system includes one or more digital works. Each digital work includes a text, audio, video, or multimedia work which has been translated to or created in a digital form and which can be recreated or accessed using suitable interpreters, such as software programs. The digital work may be a book, a periodical subscription (such as a newspaper or magazine), a song or collection of songs, a movie, a software program, or the like.

In preferred embodiments, each digital work is presented in a package which is available for purchase at a retail merchant, such as a convenience store, a gasoline station, a supermarket, an office supply outlet, a mall kiosk, or the like. After purchasing the package, the customer downloads the digital work from a remote server through the Internet to a customer node.

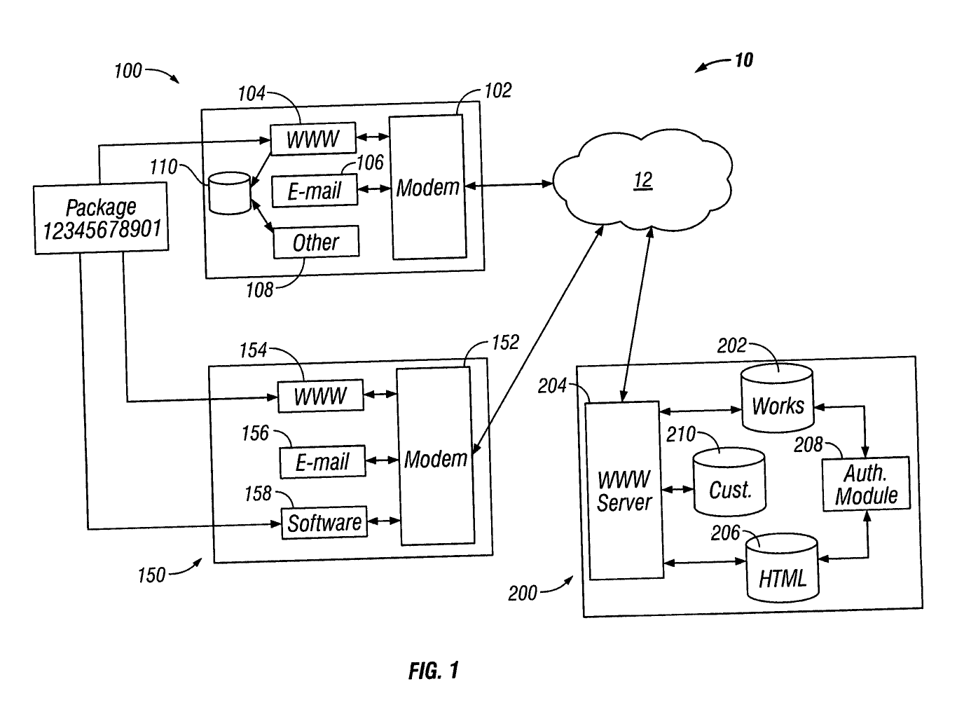

FIG. 1 illustrates the operational environment for the method and the basic components of the system 10 in accordance with embodiments of the present invention. In preferred embodiments, the system 10 includes a communications link, which in turn includes a public communications network 12, preferably the Internet 12. The communications link is connected to and serves as a medium of communication among a customer node 100, a merchant node 150, and a remote server 200. The communications link includes the Internet 12 as well as equipment for connecting the customer node 100, the merchant node 150, and the remote server 200 in a manner well known to those skilled in the art. In alternative embodiments, the communications link may include any other public or hybrid public-private communications network which transfers data packets among computers or nodes in the network.

In the embodiment illustrated in FIG. 1, the system 10 includes a customer node 100. In preferred embodiments, the customer node 100 is a conventional computer equipped with memory (such as RAM, ROM, and a hard disk), at least one processor, an input device (such as a keyboard, a mouse or other pointing device, and/or the like), and an output device (such as a display or the like). The customer node 100 also includes communications equipment for connecting to the Internet 12, such as a modem 102, and connects to the Internet 12 via a public or private connection using such equipment. As is well known in the art, the customer node 100 may connect to the Internet 12 via a wire line (such as twisted-pair telephone wire, coaxial cable, electric power line, optical fiber wire, leased line, or the like) or wireless (such as satellite, cellular, radio frequency, or the like) connection using the modem 102. A customer using the customer node 100 may obtain access to the Internet 12 using an online services network (such as America Online, CompuServe, Microsoft Network, Prodigy, or the like) or by establishing an account with an Internet Service Provider (ISP). In alternative embodiments, the customer node 100 may include other equipment for connecting to the Internet 12, such as a network card or the like, and may connect to the Internet 12 via other connections, such as a private enterprise network (e.g., LAN) which includes at least one server connected to the Internet 12 or the like. In preferred embodiments, the customer node 100 further includes a web browser 104 stored on the memory of the customer node 100, such as Microsoft® Internet Explorer developed by Microsoft Corporation or Netscape® Navigator developed by Netscape, Inc., which allows the customer to request, retrieve, and view web pages. The customer node 100 may also include an email program 106 and/or other applications 108 (such as a word processing program, a spreadsheet program, or the like) stored on the memory of the customer node 100. In alternative embodiments, the customer node 100 may be other types of systems with similar equipment and components, such as a pen-based system, a kiosk, or the like.

In the illustrated embodiment, the system 10 also includes a merchant node 150. In preferred embodiments, the merchant node 150 is a conventional computer equipped with memory (such as RAM, ROM, and a hard disk), at least one processor, an input device, an output device, and communications equipment for connecting to the Internet 12 (such as a modem 152). The merchant node 150 may also include a web browser 154, an e-mail program 156, and/or other applications (not shown) stored on the memory of the merchant node 150. These components may be identical to the components described with respect to the customer node 100 illustrated in FIG. 1. The merchant node 150 may connect to, and a retail merchant using the merchant node 150 may obtain access to, the Internet 12 in a manner similar to the manner described above with respect to the customer node 100. In preferred embodiments, the merchant node 150 further includes a validation software program 158, such as Verifone's ___________ for connecting to the Internet 12 or other public communications network and updating a database of digital works 202 stored on the remote server 200, as more fully described below. In alternative embodiments, the merchant node 150 may be other types of systems with similar equipment and components, such as a pen-based system, a kiosk, or the like. In other alternative embodiments,

In the embodiment illustrated in FIG. 1, the system 10 further includes a remote server 200 which provides a remote web site 200 on the WWW. In preferred embodiments, the remote server 200 is a conventional computer with memory (such as RAM, ROM, and a hard disk) and at least one processor. The remote server 200 is connected to the Internet 12, either directly or via a network such as a local area network (“LAN”), a wide area network (“WAN”), or the like. The remote server 200 includes a database of one or more digital works 202 stored on the memory of the remote server 200. Each digital work 202 is preferably stored as a self-contained module of compressed software and/or data. Some digital works 202, such as a book, may simply include basic files (such as a word processing document, a text file, or the like) which may be viewed using an application 108 (such as a word processing program, Adobe® Acrobat® Reader, or the like) already installed on the customer node 100. Other digital works 202, such as a software program, may include files comprising the software program itself as well as setup or installation executable files for installing the software program on the customer node 100. The database also includes identification data associated with each digital work 202, such as a unique identifier, a unique combination of a user name and a password, or the like.

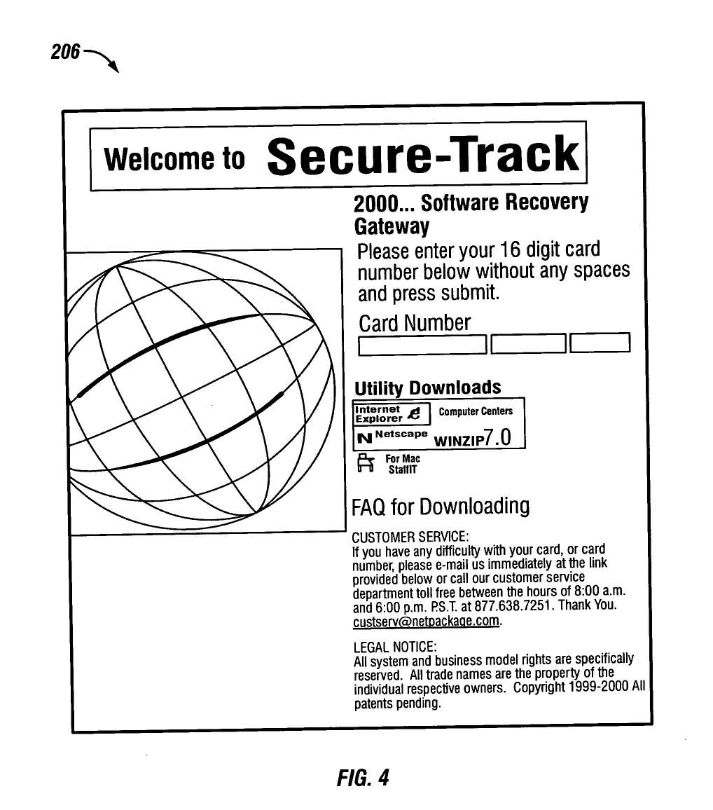

The remote server 200 further includes a web server 204 which communicates with the web browser 104 executing on the customer node 100 and/or the web browser 154 executing on the merchant node 150 using standard communications protocols, such as HyperText Transfer Protocol (“HTTP”) or the like, to display desired web pages of the remote web site 200. The web server 204 accesses one or more HTML documents 206 which are stored on the remote server 200 and which can be requested, retrieved, and viewed by the customer at the customer node 100 via the web browser 104 and/or the retail merchant at the merchant node 150 via the web browser 154. The HTML documents 206 include an interface for downloading one or more digital works 202 stored on the memory of the remote server 200, as shown in FIG. 4.

In the illustrated embodiment, the system 10 also includes a package associated with each digital work 202 which is available for purchase at a retail merchant. As described more fully below, the package includes the identification data associated with each digital work 202, information about the digital work 202, and instructions for downloading the digital work 202. After purchasing the package, the customer downloads the digital work 202 from the remote server 200 through the public communications network 12 to the customer node 100.

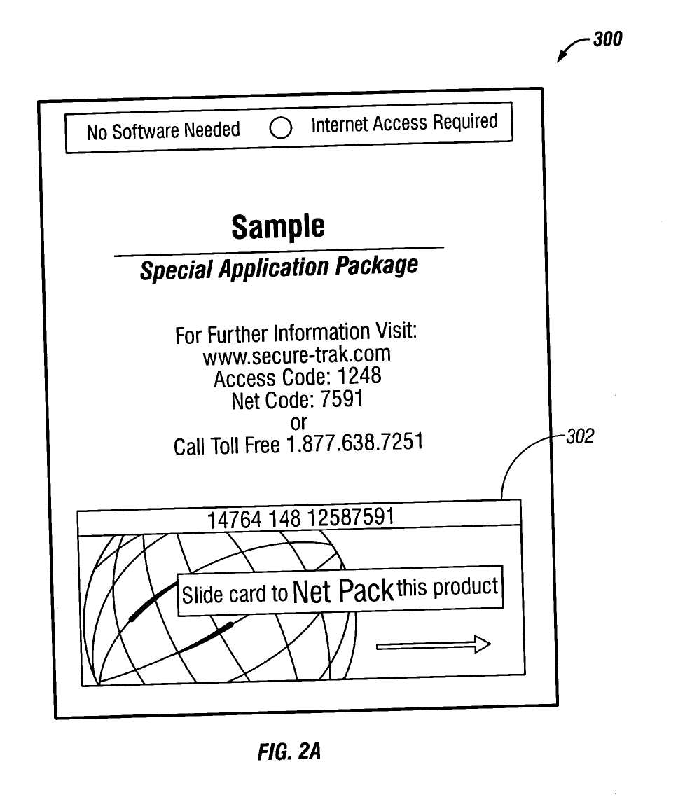

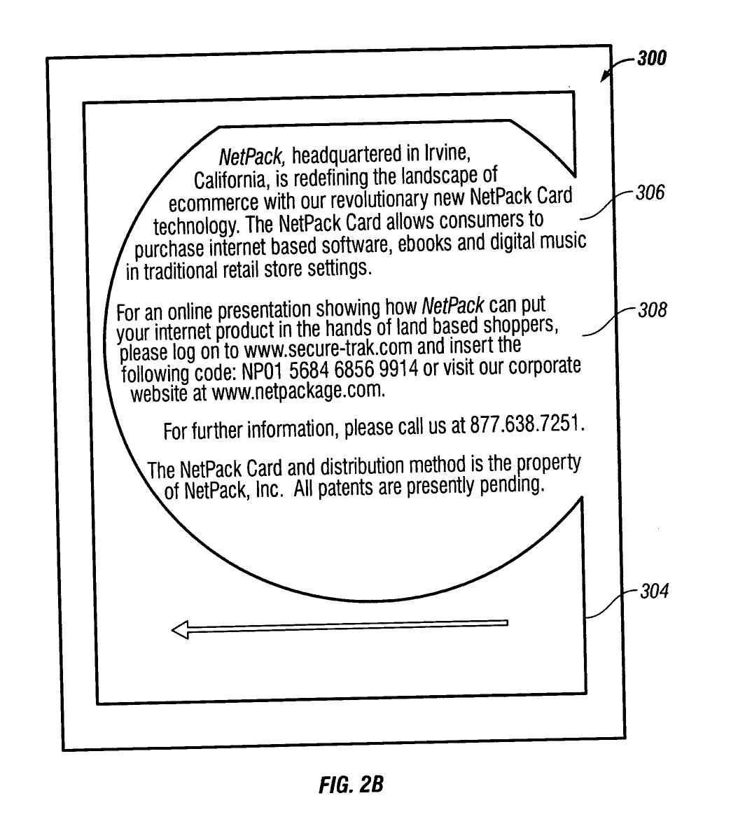

A method for distributing digital works 202 among the retail merchant at the merchant node 150, the remote server 200, and the customer at the customer node 100 through the public communications network 12, preferably the Internet, shown in FIG. 1 will now be described with reference to FIGS. 1-4. FIGS. 2A and 2B illustrate a sample package 300 as available for purchase by the customer at the retail merchant. In the illustrated embodiment, the package 300 includes identification data 302 displayed on the package 300. In one embodiment, the identification data 302 is a unique 16-character alphanumeric identifier 302. However, in alternative embodiments, the identification data 302 may be other types of data, such as a user name and/or password, may be other forms of identifiers, such as alphabetic-only or numeric-only identifiers, and may include any number of characters. In the illustrated embodiment, the package 300 also includes a magnetic strip 304 on the package 300. In alternative embodiments, the magnetic strip 304 may be omitted. The package 300 further includes information 306 about the digital work 202, such as pictures and a brief summary of the digital work 202, displayed on the package 300. Moreover, the package 300 includes instructions 308 for downloading the digital work 202 and specifies the universal resource locator address for the remote server web site 200 from which the digital work 202 is available for downloading.

In one embodiment, the customer simply purchases the package 300 associated with a desired one of the digital works 202 at the retail merchant and then downloads the desired digital work 202 from the remote server 200. No further action, such as reading the identifier 302 from the package 300 or activating or validating the package 300, is required by either the customer or the retail merchant.

In alternative embodiments, the package 300 may require activation or validation by the retail merchant. Although the identifier 302 is displayed on the outer surface of the package 300, the desired digital work 202 is not available for access or download from the remote server 200 until such activation or validation. The retail merchant inputs the identifier 302 into the merchant node 150 using a standard input device, such as typing the identifier 302 using a keyboard, scanning the identifier 302 with a bar code scanner, reading the identifier 302 from the magnetic strip 304 using a magnetic card reader, or the like. Once the identifier 302 is input into the merchant node 150, the validation software program 158 connects to the public communications network 12 using the modem 152 and sends through the public communications network 12 to the remote server 200 a request to set the status of the desired digital work 202 as available for access, specifying the identifier 302 of the desired digital work 202 included in the purchased package 300. When the remote server 200 receives this request, the database of digital works 202 is searched for the desired digital work 202 identified by the identifier 302 included in the received request, and the status of the desired digital work 202 is set as available for access.

In other alternative embodiments, the package 300 may require reading a portion or all of the identifier 302 from the package 300 in order to provide the identifier 302 to the customer. In the embodiment illustrated in FIGS. 2A and 2B, the entire identifier 302 is displayed on an outer surface of the package 300. However, in other alternative embodiments of the present invention, only a portion or none of the identifier 302 is displayed on the outer surface of the package 300. At the retail merchant, the non-displayed portion of the identifier 302 is read from the magnetic strip 304 on the package 300 and then printed on a receipt which is given to the customer. Thus, the identifier 302 includes the first portion (if any) of the identifier 302 displayed on the outer surface of the package 300 and the second portion of the identifier 302 read from the magnetic strip 304 on the package 300 and printed on the customer's receipt.

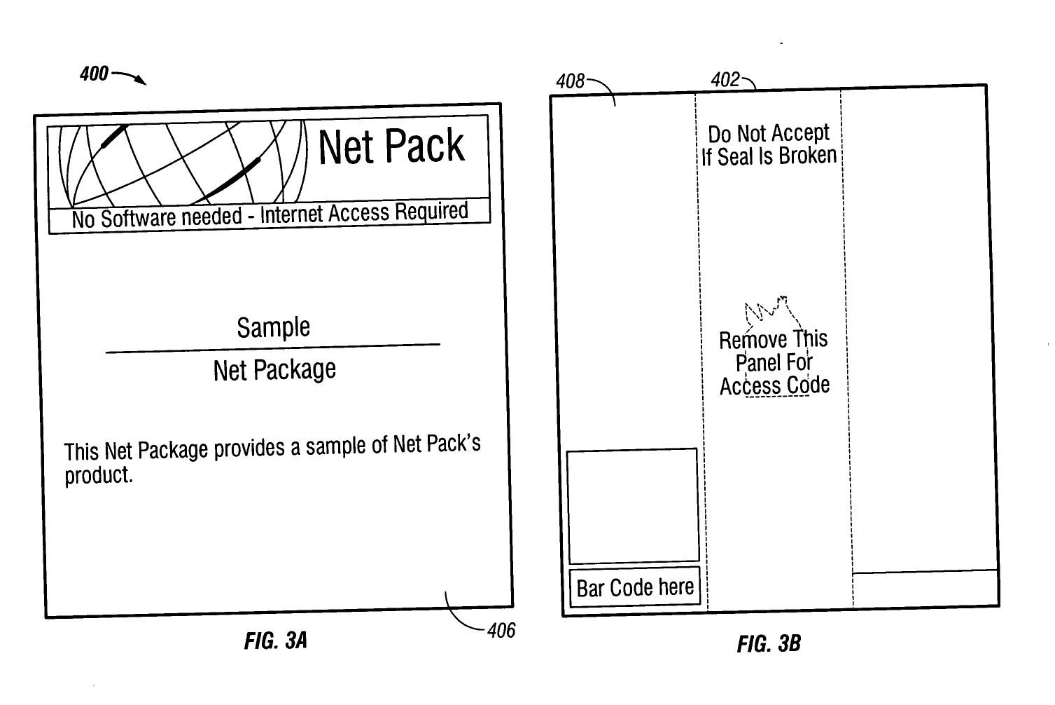

FIGS. 3A and 3B illustrate another sample package 400 as available for purchase by the customer at the retail merchant. In the illustrated embodiment, the package 400 includes similar elements to the package 300 shown in FIGS. 2A and 2B. The package 400 includes information 406 about the digital work 202, such as pictures and/or a brief summary of the digital work 202, displayed on the package 400. The package 400 may be opened and include multiple pages of information about the digital work 202 (not shown). The package 400 also includes instructions 408 for downloading the digital work 202 and specifies the universal resource locator address for the remote server web site 200 from which the digital work 202 is available for downloading. As shown, the package 400 further includes identification data disposed on an inside surface of the package 400 and sealed within the package 400 behind a tamper proof, removable panel 402. In one embodiment, the identification data is a unique combination of a user name and password. However, in alternative embodiments, the identification data may be other types of data, such as an alphabetic, numeric, or alphanumeric identifier. In other alternative embodiments, a first portion of the identification data may be displayed on the outer surface of the package 400, and a second portion of the identification data may be disposed on the inside surface of the package 400 and sealed within the package 400 behind the removable panel 402. In further alternative embodiments, the package 400 may also include a magnetic strip (not shown) on the package 400, and a first portion of the identification data may be stored on and read from the magnetic strip, and a second portion of the identification data may be disposed on the inside surface of the package 400 and sealed within the package 400 behind the removable panel 402.

In preferred embodiments, once the customer purchases the package 300 or 400 associated with a desired one of the digital works 202 at the retail merchant, the customer then accesses the remote web site 200 via the web browser 104 on the customer node 100. The customer node 100 sends through the public communications network 12 to the remote server 200 a request for the home page 206 of the remote web site 200. When the remote server 200 receives this request, the web server 204 on the remote server 200 retrieves the home page 206 of the remote web site 200 and sends the requested home page 206 to the customer node 100 through the public communications network 12. The home page 206 is then displayed to the customer at the customer node 100 via the web browser 104, as shown in FIG. 4. In the illustrated embodiment, the home page 206 provides an interface for downloading the desired digital work 202 from the remote server 200 through the public communications network 12 to the customer node 10. The customer inputs the identifier 302 or 402 for the desired digital work using a standard input device, such as typing the identifier 302 using a keyboard or reading the identifier 302 from the magnetic strip 304 using a magnetic card reader, and then clicks the “Submit” button. The customer node 100 sends through the public communications network 12 to the remote server 200 a request for the desired digital work 202, specifying the identifier 302 or 402 of the desired digital work 202 included in the purchased package 300 or 400. When the remote server 200 receives this request, an authorization module 208 on the remote server 200 searches the database of digital works 202 for the desired digital work 202 specified by the identifier 302 or 402 included in the received request. If the desired digital work 202 is found, it is transmitted (i.e., downloaded) from the remote server 200 through the public communications network 12 to the customer node 100. When the desired digital work 202 is received at the customer node 100, it is stored on the memory of the customer node 100 for subsequent access and use by the customer. If the desired digital work 202 is not found, an error message is transmitted from the remote server 200 through the public communications network 12 to the customer node 100, indicating that the desired digital work 202 was not found or not available on the remote server 200.

In one embodiment, before or after the desired digital work 202 is downloaded from the remote server 200, the remote server 200 sends a request for customer registration data through the public communications network 12 to the customer node 100. An HTML document 206 is displayed at the customer node 100, asking the customer to enter demographic information (such as the customer's name, address, phone number(s), e-mail address, age, sex, marital status, number of children, occupation, income, and interests). This information is then sent to the remote server 200 and stored in a customer database 210 on the memory of the remote server 200. The information stored in the customer database 210 may then be used to market other digital works 202 and/or other related products and services to registered customers.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A method for distributing digital works among a retail merchant, a remote server, and a customer at a customer node, each digital work having identification data associated therewith, the remote server being intermittently coupled through a communications link which includes a public communications network to the customer node, the method comprising the steps of:
storing the digital works and their associated identification data on a memory of the remote server;
purchasing from the retail merchant a package associated with a desired one of the digital works, wherein the package includes the desired digital work's identification data;
sending a request to access the desired digital work from the customer node through the public communications network to the remote server, the request specifying the desired digital work's identification data included in the purchased package;
receiving at the remote server the request to access the desired digital work;
searching the digital works stored on the remote server for the desired digital work specified by the identification data in the received request
transmitting the desired digital work from the remote server through the public communications network to the customer node;
receiving at the customer node the desired digital work;
storing the desired digital work on a memory of the customer node.

2. The method of claim 1, wherein the identification data for each of the digital works stored on the remote server includes a unique identifier, and further wherein the unique identifier is displayed on an outer surface of the package.

3. The method of claim 2, wherein the remote server is intermittently coupled through the communications link which includes the public communications network to a merchant node used by the retail merchant, and further wherein the identification data for each of the digital works stored on the remote server further includes a status indicating whether the digital work is available or not available for access, the method further comprising the steps of:
receiving a request to set the status of the desired digital work as available for access at the remote server through the public communications network from the merchant node, the request specifying the desired digital work's unique identifier included in the purchased package;
searching the digital works stored on the remote server for the desired digital work specified by the unique identifier in the received request; and
setting at the remote server the status of the desired digital work as available for access.

4. The method of claim 1, wherein the identification data for each of the digital works stored on the remote server includes a unique combination of an identifier and a password, and further wherein the unique combination of the identifier and the password are disposed on an inner surface of the package and sealed within the package, the method further comprising the step of:
after purchasing from the retail merchant the package associated with the desired digital work, opening the package to reveal the desired digital work's unique combination of the identifier and the password disposed on the inner surface of the package.

5. The method of claim 1, wherein the identification data for each of the digital works stored on the remote server includes a unique identifier, and further wherein a first portion of the unique identifier is displayed on an outer surface of the package and a second portion of the unique identifier is stored on a magnetic strip on the package, the method further comprising the steps of:
after purchasing from the retail merchant the package associated with the desired digital work, reading the second portion of the unique identifier from the magnetic strip on the package; and
printing the second portion of the unique identifier for the customer.

6. The method of claim 1, wherein the identification data for each of the digital works stored on the remote server includes a unique identifier, and further wherein a first portion of the unique identifier is displayed on an outer surface of the package and a second portion of the unique identifier is disposed on an inner surface of the package and sealed within the package, the method further comprising the step of:
after purchasing from the retail merchant the package associated with the desired digital work, opening the package to reveal the second portion of the unique identifier disposed on the inner surface of the package.

7. The method of claim 1, further comprising the steps of:
sending a request for customer registration data from the remote server through the public communications network to the customer node;
inputting at the customer node the requested customer registration data;
transmitting the inputted customer registration data from the customer node through the public communications network to the remote server;
receiving at the remote server the transmitted customer registration data; and
storing the transmitted customer registration data on the memory of the remote server.

8. The method of claim 1, wherein the public communications network comprises the Internet.

9. A system for distributing digital works, each digital work having identification data associated therewith, the system comprising:
a. a package associated with a desired one of the digital works, wherein the package includes the desired digital work's identification data and is purchased from a retail merchant;
b. a communications link which includes a public communications network;
c. a customer node used by a customer, the customer node comprising:
i. memory;
ii. a processor connected to the memory of the customer node; and
iii. equipment connected to the processor of the customer node for coupling to the communications link which includes the public communications network; and
iv. logic for performing the steps of:
1) sending a request to access the desired digital work through the public communications network, the request specifying the desired digital work's identification data included in the purchased package;
2) receiving the desired digital work through the public communications network; and
3) storing the desired digital work on the memory of the customer node; and
d. a remote server comprising:
i. memory;
ii. a processor connected to the memory of the remote server; and
iii. equipment connected to the processor of the remote server for coupling to the communications link which includes the public communications network;
iv. the digital works and identification data associated with each of the digital works stored on the memory of the remote server; and
v. logic for performing the steps of:
1) receiving the request to assess the desired digital work through the public communications network from the customer node;
2) searching the digital works stored on the remote server for the desired digital work specified by the identification data in the received request; and
3) transmitting the desired digital work through the public communications network to the customer node.

10. The system of claim 9, wherein the identification data for each of the digital works stored on the remote server includes a unique identifier, and further wherein the unique identifier is displayed on an outer surface of the package.

11. The system of claim 9, wherein the remote server is intermittently coupled through the communications link which includes the public communications network to a merchant node used by the retail merchant, the identification data for each of the digital works stored on the remote server further includes a status indicating whether the digital work is available or not available for access, and the remote server further comprises logic for performing the steps of:
receiving a request to set the status of the desired digital work as available for access through the public communications network from the merchant node, the request specifying the desired digital work's unique identifier included in the purchased package;
searching the digital works stored on the remote server for the desired digital work specified by the unique identifier in the received request; and
setting the status of the desired digital work as available for access.

12. The system of claim 9, wherein the identification data for each of the digital works stored on the remote server includes a unique combination of an identifier and a password, and further wherein the unique combination of the identifier and the password are disposed on an inner surface of the package and sealed within the package.

13. The system of claim 9, wherein the identification data for each of the digital works stored on the remote server includes a unique identifier, and further wherein a first portion of the unique identifier is displayed on an outer surface of the package and a second portion of the unique identifier is stored on a magnetic strip on the package.

14. The system of claim 9, wherein the identification data for each of the digital works stored on the remote server includes a unique identifier, and further wherein a first portion of the unique identifier is displayed on an outer surface of the package and a second portion of the unique identifier is disposed on an inner surface of the package and sealed within the package.

15. The system of claim 9, wherein the public communications network comprises the Internet.
